(19) United States
(12) Patent Application Publication
(10) Pub. No.: US 2011/0154996 A1
(43) Pub. Date: Jun. 30, 2011

(54) Cake Preparation and Serving Assembly

(76) Inventor: A.J. Monteith, Brevard, NC (US)

(21) Appl. No.: 12/650,655

(22) Filed: Dec. 31, 2009

(51) Int. Cl. A47J 47/16; A47J 37/01

(52) U.S. Cl. 99/357

(57) ABSTRACT

A cake preparation and serving assembly is provided having a molding pan, a serving platter, and an invertable product stand. The molding pan includes a cylindrical bottom connected to a frusto-conical continuous closed-loop side wall and a cone structure extending vertically centrally from the bottom.

### BACKGROUND OF THE INVENTION

This invention relates to a cake preparation and serving assembly. Cake molds with one open end, one closed end and side walls are sold commercially for the preparation of cakes in residential and commercial kitchens. The closed end and side walls define a hollow cavity that becomes the three-dimensional shape of a cake molded by the baking pan.

Ring shaped baking pans for making angel food cake or a ring shaped pan for Bundt cakes, have an annular hollow volume at the open end. The hollow volume is filled with cake batter and then baked. After baking, the pan is inverted to remove the shaped cake from the open end. Thus, the open end is used to form the bottom of the final cake.

It can thus be seen that a number of devices have been used in the molding and baking of cakes to obtain molded desserts in a variety of configurations and for a variety of shaped configurations as described in the prior art. While cakes are commonly referred to in the literature as being domed, in effect this is an occurrence which comes about as the batter expands during baking.

Many prior art devices and techniques mold and bake dough of breads, batters of cakes, cookies, and other baked goods into various shapes including containers which may be used to hold other foods. For example, U.S. Pat. No. 5,226,352 issued Jul. 13, 1993 is directed toward a baking assembly which has an outer dome shaped member and an inner dome shaped member as shown in FIGS. 6 and 7. A flange extends outward from the upper edge of the outer dome member to seat a flange extending from the upper edge of the inner dome member. The flanges are held together by a “C” clamp or other fastening means. The inner dome shaped member is coated with a non-stick coating on its inside surface and its outside surface allowing cake or dough to be baked in the outer dome mold and the inner mold.

A baked layered product with an apparatus for making same is shown in U.S. Pat. No. 3,831,507, issued Aug. 27, 1974. This baking assembly uses three baking pans to form a cylindrical Bundt body and lid which is placed over the body to hold the filling therein. U.S. Pat. No. 1,487,906 issued Mar. 25, 1924 is directed toward two nesting rectangular baking pans, the inner pan having flange members adapted to sit on a shelf formed in the outer pan with the composite unit being and held in place by a strip of sheet metal which engages an upwardly extending flange of the outer pan.

There is a need for improvements for a cake preparation and serving assembly that simplifies and makes more reliable the process of baking a shaped cake such as a Bundt cake.

### SUMMARY OF THE INVENTION

According to one aspect of the present invention, there is provided a cake preparation and serving assembly including a molding pan, a serving platter, and an invertable product stand.

According to one feature of the one aspect of the present invention, the molding pan of the cake preparation and serving assembly includes a cylindrical bottom connected to a frusto-conical continuous closed-loop side wall and a cone structure extending vertically centrally from the bottom.

According to another feature of the one aspect of the present invention, the invertable product stand of the cake preparation and serving assembly is formed of a ring-shaped base plate having a cylindrically shaped central void and a plurality of stand-off legs.

According to a further feature of the one aspect of the present invention, the base plate of the invertable product stand of the cake preparation and serving assembly has an outer diameter compatibly configured with respect to the inner diameter of the molding pan and the diameter of the central void of the invertable product stand is compatibly configured with respect to the cross section of the cone structure of the molding pan such that the invertable product stand is cooperatively operable with the molding pan to facilitate the removal of a cured or baked food product from the molding pan.

According to an additional feature of the one aspect of the present invention, the serving platter of the cake preparation and serving assembly is operable to support a food product after the food product has been transferred from the molding pan via the invertable product stand.

### BRIEF DESCRIPTION OF THE DRAWINGS

An embodiment of the present invention is now described with reference to the following Figures of the drawings:

FIG. 1 is a perspective view of one embodiment of the cake preparation and serving assembly;

FIG. 2 is a perspective view of the one embodiment of the cake preparation and serving assembly during one step of a food preparation and serving process;

FIG. 3 is a perspective view of the one embodiment of the cake preparation and serving assembly during one step of a food preparation and serving process;

FIG. 4 is a perspective view of the one embodiment of the cake preparation and serving assembly during one step of a food preparation and serving process;

FIG. 5 is a perspective view of the one embodiment of the cake preparation and serving assembly during one step of a food preparation and serving process;

FIG. 6 is a perspective view of the one embodiment of the cake preparation and serving assembly during one step of a food preparation and serving process;

FIG. 7 is a perspective view of the one embodiment of the cake preparation and serving assembly during one step of a food preparation and serving process; and

FIG. 8 is a perspective view of the one embodiment of the cake preparation and serving assembly during one step of a food preparation and serving process.

### DETAILED DESCRIPTION OF AN EMBODIMENT

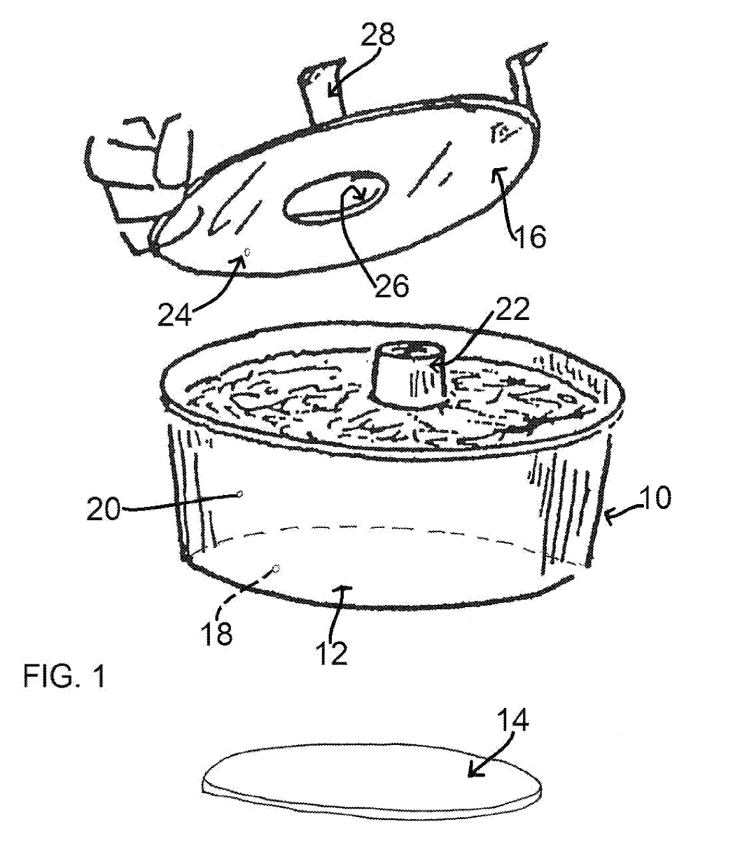

With reference now to FIG. 1, which is a perspective view of the cake preparation and serving assembly of the present invention, one embodiment of the cake preparation and serving assembly is illustrated and is generally designated as the cake preparation and serving assembly 10. The cake preparation and serving assembly 10 is operable to shape or mold a suitable food product such as, for example, cake batter, batter for other bakery goods, dessert food products such as gelatins or puddings, into a “ring” shape. The cake preparation and serving assembly 10 includes a molding pan 12, a derving platter 14, and an invertable product stand 16.

With further reference to the molding pan 12, the molding pan includes a cylindrical bottom 18 connected to a frusto-conical continuous closed-loop side wall 20, and a cone structure 22 extending vertically centrally from the bottom 18. The molding pan 12 provides a suitable structure into which a liquid, dry powder, or liquid-solid suspension in the form of, for example, a cake batter, can be poured and the molding pan 12 is operable to retain the poured-in food substance while the food substance is subjected to heating in, for example, a cooking oven. In this regard, the molding pan 12 can be constructed of sheet steel or stainless steel but can be constructed, as well, of copper, aluminum, cast iron, heat-resistant glass, porcelain, or any other material suitable for retaining a food product while being subjected to heat or a thermal treatment. The molding pan 12 can also be provided with a non-stick coating such as a coating of fluorocarbon polymers, tetrafluroethlene, and fluorinated propylene. The frusto-conical shape of the molding pan 12 facilitates the removal of the cured food product from the molding pan upon the completion of the heat or thermal treatment. As can be appreciated, the cone structure 22 ensures that the molded food product handled in the molding pan 12 has a hollow center upon being cured or fully baked.

With reference now to the serving platter 14, the serving platter 14 can be comprised of glass or ceramic material and is of a solid cylindrical geometry. With reference now to the invertable product stand 16, the invertable product stand 16 is formed of a ring-shaped base plate 24 having a cylindrically shaped central void 26. The invertable product stand 16 also includes a plurality of stand-off legs 18. The base plate 24 of the invertable product stand 16 has an outer diameter ROD compatibly configured with respect to the inner diameter PID of the molding pan 12 and the diameter of the central void 26 of the invertable product stand 16 is compatibly configured with respect to the cross section of the cone structure 22 of the molding pan 12 in a manner explained hereinbelow such that the invertable product stand 16 is cooperatively operable with the molding pan 12 to facilitate the removal of a cured or baked food product from the molding pan 12.

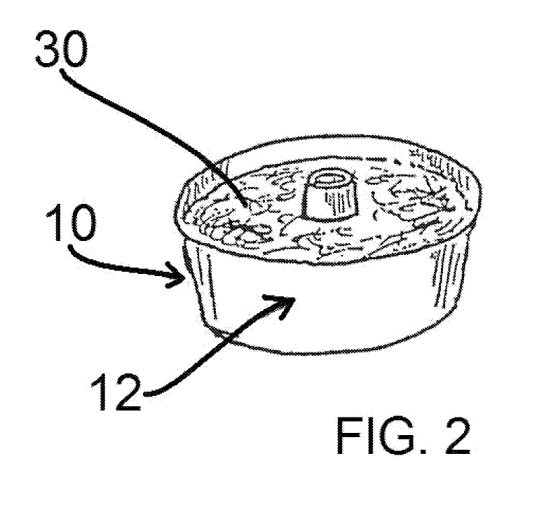

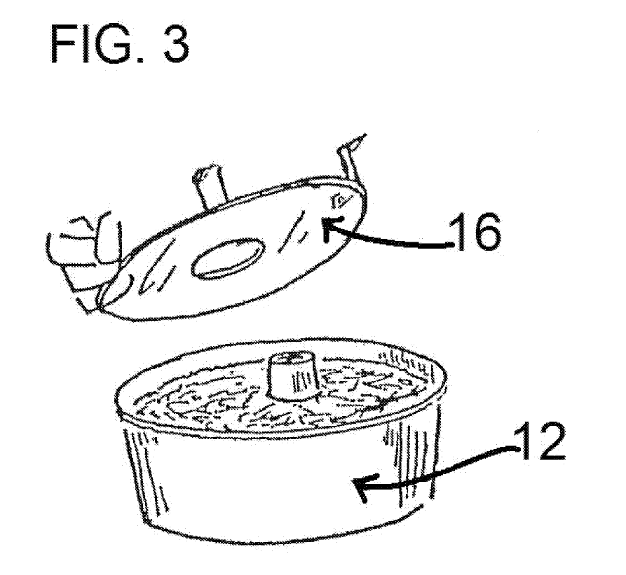

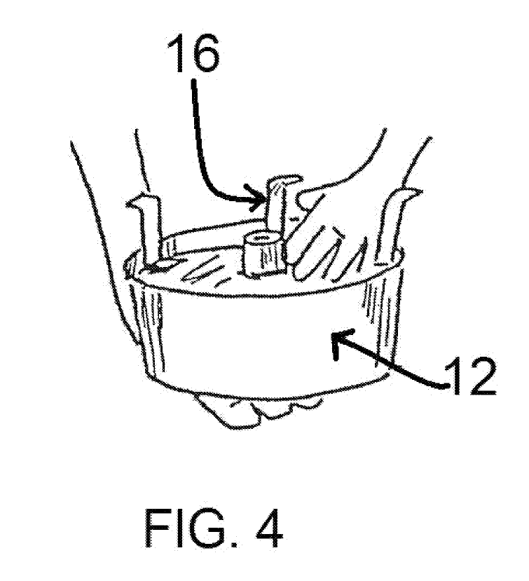

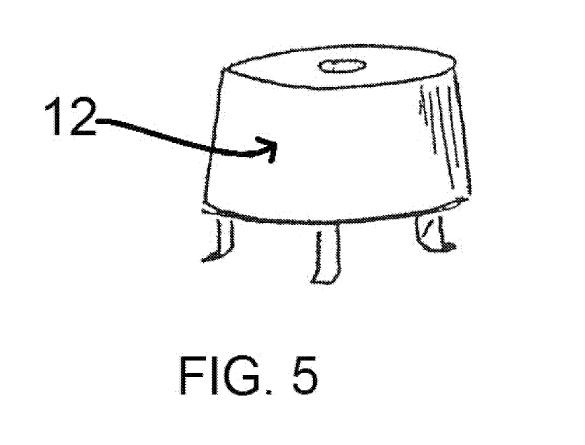

With reference now to FIGS. 2-8, each of which illustrates the operation of the cake preparation and serving assembly 10 during a food preparation and serving process, the operation of the cake preparation and serving assembly 10 to prepare a food product and to support the prepared food product for serving will now be described. As seen in FIG. 2, the cake preparation and serving assembly 10, upon the completion of a baking operation, retains a cured or baked food product such as, for example, a cake shell 30. The cake shell 30 had been initially formed of a flowable cake batter material that had been poured into the molding pan 12 to a level below the top of the cylindrical wall 20 of the molding pan 12 and, upon baking of the food material in a cooking oven (now shown), the cake shell 30 was formed as the cake batter material was subjected to thermal treatment in the cooking oven. As seen in FIG. 3, a user grasps one of the legs 28 of the invertable product stand 16 and positions the invertable product stand 16 such that the cone 22 of the molding pan 12 is inserted through the central void 26 of the invertable product stand 16 and the base plate 24 rests atop the cake shell 30. Then, as seen in FIG. 4, a user places one hand below the bottom 18 of the molding pan 12 and places a hand on the top of the invertable product stand 16 as it rests on the cake shell 30 in preparation for the next step of the food preparation process. In this next step, as shown in FIG. 5, the user turns over or flips the molding pan 12 and the invertable product stand 16 while maintaining the invertable product stand 16 in contact with the top of the cake shell 30 and the user lowers the combined sub-assembly of the molding pan 12 and the invertable product stand 16 such that this sub-assembly is supported by the legs 28 of the invertable product stand 16 resting on a surface such as, for example, a surface of a table 32.

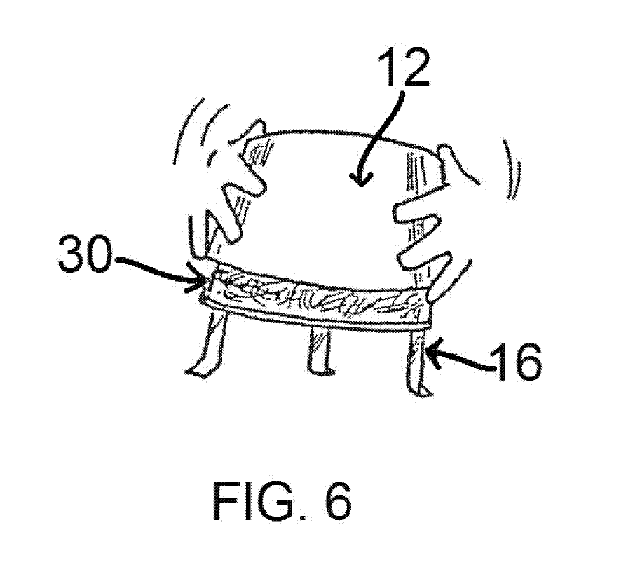

With reference now to FIG. 6, in the next step of the food preparation process, the user removes the molding pan 12 while the cake shell 30 is supported on the invertable product stand 16. In this removal step, the user may slightly rotate or slightly vibrate the molding pan 12 to facilitate its disengagement from the cake shell 30. At the conclusion of this step, the cake shell 30 is now supported on the invertable product stand 16 and is no longer covered by the molding pan 12.

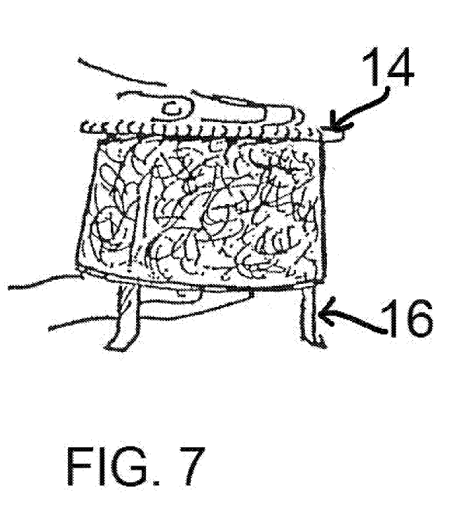

As seen in FIG. 7, the user then positions the serving platter 14 on the top side of the cake shell 12 and a hand on the bottom of the base plate 24 of the invertable product stand 16 and another hand on the serving platter 14 in preparation for the next step of the food preparation and serving process.

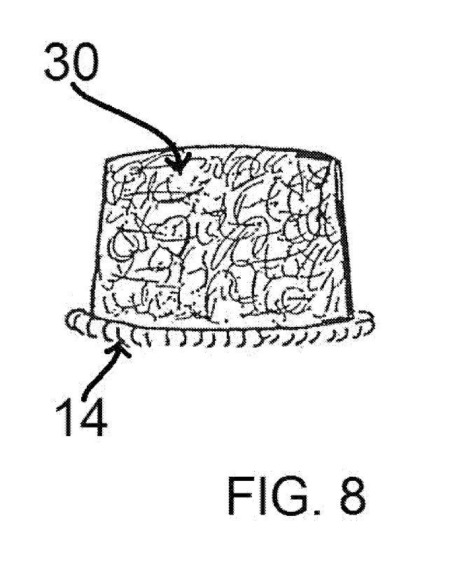

As seen in FIG. 8, the user has turned over or flipped the sub-assembly of the invertable product stand 16 and the serving platter 14 while retaining both components in engagement with the cake shell 30, with the result that the cake shell 30 is now supported on the serving platter 14. At this time, the user can remove the invertable product stand 16 which rests upon the top of the cake shell 30, thereby resulting in the serving disposition illustrated in FIG. 8 in which the cake shell 30 is supported on the serving platter 14. Thereafter, the user can apply additional food products such as, for example, frosting, candy, fruits, or other known cake-decorating food products or the cake shell can be placed in, for example, a refrigerator, for serving at a later time or can be placed on a dining table for immediate consumption.

The cake preparation and serving assembly of the present invention has been exemplarily disclosed and illustrated with respect to a cake preparation and serving assembly for preparing a Bundt cake but it is to be understood that the cake preparation and serving assembly can as well be deployed for preparing and serving any other suitable food product in which it is desirable or advantageous to have the features that have been described herein. It will be appreciated by those skilled in the art that other shapes and geometries of cake preparation and serving assemblies are possible, and that the specifics of material of which it is made can be changed without departing from scope of the invention. The molding pan may be formed or stamped from a solid piece of material or spun from aluminum instead of formed from a sheet.

From the foregoing description of one embodiment of the invention, it will be apparent that many modifications may be made therein. It will be understood that this embodiment of the invention is an exemplification of the invention only and that the invention is not limited thereto.

What is claimed is:

1. A cake preparation and serving assembly comprising:
a molding pan;
a serving platter; and
an invertable product stand.

2. A cake preparation and serving assembly according to claim 1, wherein the molding pan includes a cylindrical bottom connected to a frusto-conical continuous closed-loop side wall and a cone structure extending vertically centrally from the bottom.

3. A cake preparation and serving assembly according to claim 2, wherein the invertable product stand is formed of a ring-shaped base plate having a cylindrically shaped central void and a plurality of stand-off legs.

4. A cake preparation and serving assembly according to claim 3, wherein the base plate of the invertable product stand has an outer diameter compatibly configured with respect to the inner diameter of the molding pan and the diameter of the central void of the invertable product stand is compatibly configured with respect to the cross section of the cone structure of the molding pan such that the invertable product stand is cooperatively operable with the molding pan to facilitate the removal of a cured or baked food product from the molding pan.

5. A cake preparation and serving assembly according to claim 4, wherein the serving platter is operable to support a food product after the food product has been transferred from the molding pan via the invertable product stand.
